(19) United States
(12) Patent Application Publication
(10) Pub. No.: US 2026/0341829 A1
(43) Pub. Date: Oct. 29, 2026

(54) RECHARGEABLE ENERGY STORAGE SYSTEM HEATING

(71) Applicant: GM GLOBAL TECHNOLOGY OPERATIONS LLC, Detroit, MI (US)

(72) Inventors: Neeraj S. Shidore, Novi, MI (US); Chandra S. Namuduri, Troy, MI (US); Suresh Gopalakrishnan, Troy, MI (US); Chunhao J. Lee, Troy, MI (US); Renato Amorim Torres, Pontiac, MI (US)

(73) Assignee: GM GLOBAL TECHNOLOGY OPERATIONS LLC, Detroit, MI (US)

(21) Appl. No.: 19/187,312

(22) Filed: Apr. 23, 2025

(51) Int. Cl. H01M 10/637; B60L 50/60; B60L 53/10; H01M 10/48; H01M 10/615; H01M 10/625; H01M 10/667; H02M 1/00

(52) U.S. Cl. CPC H01M 10/637; B60L 50/60; B60L 53/11; H01M 10/486; H01M 10/615; H01M 10/625; H01M 10/667; H02M 1/0009; H02M 1/0054

(57) ABSTRACT

A system includes a rechargeable energy storage system, a quasi-resonant circuit and a controller. The rechargeable energy storage system has a positive terminal, a negative terminal, an internal impedance, and a battery temperature sensor. The battery temperature sensor is operational to generate a battery temperature signal representative of a storage system temperature within the rechargeable energy storage system. The quasi-resonant circuit is coupled between the positive terminal and the negative terminal, and is operational to draw an alternating current signal through the internal impedance of the rechargeable energy storage system in response to a resonant control signal. The controller is coupled to the quasi-resonant circuit and is operational to sense the storage system temperature within the rechargeable energy storage system via the battery temperature signal, and generate the resonant control signal in response to the battery temperature signal to heat the rechargeable energy storage system.

### INTRODUCTION

The present disclosure relates to a system and a method for rechargeable energy storage system heating.

If heat generation for a vehicle battery pack warmup is inefficient and/or slow (i.e., a cold ambient), the results could be a diminished range and a performance degradation of the vehicle. Positive temperature coefficient heaters have size and warranty constraints. Furthermore, direct current fast charging performance of the battery pack is poor at low temperatures.

Accordingly, those skilled in the art continue with research and development efforts in the field of heating rechargeable energy storage system of a vehicle.

### SUMMARY

A system is provided herein. The system includes a rechargeable energy storage system, a quasi-resonant circuit, and a controller. The rechargeable energy storage system has a positive terminal, a negative terminal, an internal impedance, and a battery temperature sensor. The battery temperature sensor is operational to generate a battery temperature signal representative of a storage system temperature within the rechargeable energy storage system. The quasi-resonant circuit is coupled between the positive terminal and the negative terminal, and is operational to draw an alternating current signal through the internal impedance of the rechargeable energy storage system in response to a resonant control signal. The controller is coupled to the quasi-resonant circuit and operational to sense the storage system temperature within the rechargeable energy storage system via the battery temperature signal, and generate the resonant control signal in response to the battery temperature signal to heat the rechargeable energy storage system.

In one or more embodiments of the system, the quasi-resonant circuit comprises a half-bridge power module with a center node, an inductor coupled to the center node, and a resonant capacitor coupled in parallel with the half-bridge power module.

In one or more embodiments, the system includes a current sensor operational to generate a measured current signal representative of the alternating current signal. The controller is further operational to generate the resonant control signal in response to the measured current signal.

In one or more embodiments of the system, the current sensor is in series with the inductor.

In one or more embodiments of the system, the half-bridge power module has an AC output terminal, and the current sensor is at the AC output terminal.

In one or more embodiments of the system, the current sensor is a current mirror in series with the half-bridge power module.

In one or more embodiments of the system, the current sensor is a battery current sensor within the rechargeable energy storage system.

In one or more embodiments of the system, the rechargeable energy storage system includes a pair of direct current fast charging terminals through which the rechargeable energy storage system is rechargeable. The inductor is directly connected to one terminal of the pair of direct current fast charging terminals. A switch is disposed between the quasi-resonant circuit and the positive terminal of the rechargeable energy storage system, and controlled by the resonant control signal to alternatively connect and isolate the quasi-resonant circuit from the rechargeable energy storage system.

In one or more embodiments of the system, the controller is further operational to generate a pulse width modulated signal in response to the measured current signal. The half-bridge power module has a first transistor with a first gate and a second transistor with a second gate. The second gate receives the pulse width modulated signal.

In one or more embodiments of the system, a switching frequency of the quasi-resonant circuit is tuned for zero current switching in the second transistor.

In one or more embodiments of the system, a switching frequency of the quasi-resonant circuit is tuned for a set peak current through the half-bridge power module.

In one or more embodiments of the system, the quasi-resonant circuit further comprises a resonant switch in series with the inductor and controlled by the resonant control signal to alternatively connect and isolate the quasi-resonant circuit from the rechargeable energy storage system.

In one or more embodiments, the system includes a traction inverter coupled to the positive terminal and the negative terminal of the rechargeable energy storage system. The traction inverter provides a filter capacitor between the positive terminal and the negative terminal. The filter capacitor is coupled in parallel with the resonant capacitor while the quasi-resonant circuit is operational.

In one or more embodiments of the system, the quasi-resonant circuit is operational while the rechargeable energy storage system is charging.

In one or more embodiments of the system the rechargeable energy storage system, the quasi-resonant circuit, and the controller are disposed in a vehicle. The quasi-resonant circuit is operational while the vehicle is in motion.

In one or more embodiments of the system, the controller is further operational to dither the resonant control signal.

In one or more embodiments of the system, the rechargeable energy storage system has a state-of-charge and a plurality of battery relays. The controller is further operational to generate the resonant control signal in response to one or more of the state-of-charge and a plurality of relay temperatures of the plurality of battery relays.

In one or more embodiments of the system, the quasi-resonant circuit is directly connected to the positive terminal and the negative terminal of the rechargeable energy storage system. The resonant control signal is transferred from the controller directly to the quasi-resonant circuit.

A method for heating a rechargeable energy storage system is provided herein. The method includes generating with a battery temperature sensor a battery temperature signal representative of a storage system temperature within the rechargeable energy storage system, where the rechargeable energy storage system has an internal impedance, receiving at a controller the battery temperature signal, generating in the controller a resonant control signal in response to the battery temperature signal, and drawing with a quasi-resonant circuit an alternating current signal from the rechargeable energy storage system through the internal impedance in response to the resonant control signal to heat the rechargeable energy storage system.

A vehicle is provided herein. The vehicle includes a rechargeable energy storage system, a traction inverter, a quasi-resonant circuit, and a controller. The rechargeable energy storage system has a positive terminal, a negative terminal, an internal impedance, and a battery temperature sensor. The battery temperature sensor is operational to generate a battery temperature signal representative of a storage system temperature within the rechargeable energy storage system. The traction inverter is coupled to the positive terminal and the negative terminal of the rechargeable energy storage system. The quasi-resonant circuit is coupled between the positive terminal and the negative terminal, and operational to draw an alternating current signal through the internal impedance of the rechargeable energy storage system in response to a resonant control signal. The controller is coupled to the quasi-resonant circuit and operational to sense the storage system temperature within the rechargeable energy storage system via the battery temperature signal, and generate the resonant control signal in response to the battery temperature signal to heat the rechargeable energy storage system.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic diagram illustrating a context of a system in accordance with one or more exemplary embodiments.

FIG. 2 is a schematic diagram of an electronic configuration for rechargeable energy storage system heating in accordance with one or more exemplary embodiments.

FIG. 3 is a schematic diagram of another electronic configuration in accordance with one or more exemplary embodiments.

FIG. 4 is a schematic diagram of still another electronic configuration is shown in accordance with one or more exemplary embodiments.

FIG. 5 is a flow diagram of a method of operation for a controller in accordance with one or more exemplary embodiments.

### DETAILED DESCRIPTION

Embodiments of the disclosure provide a system and/or a method for rechargeable energy storage system heating suitable for use in a vehicle. The system includes a rechargeable energy storage system (RESS), a quasi-resonant circuit (QRC), and a controller. A battery temperature sensor within rechargeable energy storage system generates a battery temperature signal representative of a storage system temperature within the rechargeable energy storage system. The quasi-resonant circuit draws an alternating current (AC) signal through an internal impedance of the rechargeable energy storage system in response to a resonant control signal. The AC signal heats the rechargeable energy storage system while the vehicle is stationary and while the vehicle is moving. The controller senses the storage system temperature within the rechargeable energy storage system via the battery temperature signal, and generates the resonant control signal in response to the battery temperature signal to control the heating. The system/method may be configured with a stand-alone QRC, direct current fast charging (DCFC) equipment, a permanently powered QRC, and may use a capacitance in a traction converter in parallel with the QRC. In various embodiments, the QRC may be packaged inside the battery disconnect unit (BDU)

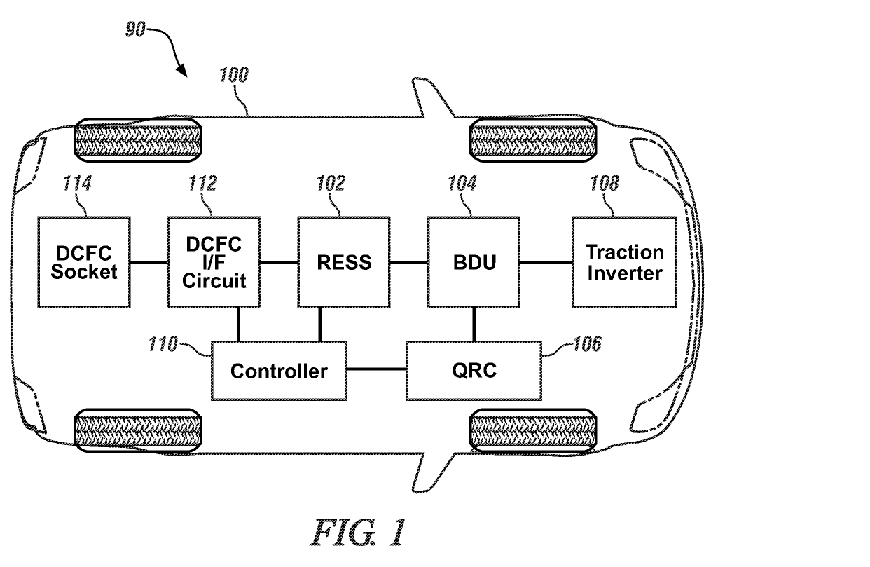

Referring to FIG. 1, a schematic diagram illustrating a context of a system 90 is shown in accordance with one or more exemplary embodiments. The system 90 generally includes a vehicle 100 having a rechargeable energy storage system 102 (or battery pack), an optional battery disconnect unit 104, a quasi-resonant circuit 106 (QRC), a traction inverter 108, a controller 110, an optional direct current fast charging (DCFC) interface circuit 112 and an optional DCFC socket 114.

The vehicle 100 may include, but is not limited to, mobile objects such as a passenger vehicle, a truck, an autonomous vehicle, an electric-powered vehicle, a hybrid vehicle, a motorcycle, a boat, a farm vehicle, a train and/or an aircraft. In some embodiments, the vehicle 100 may include stationary objects such as billboards, kiosks and/or marquees. Other types of vehicles 100 may be implemented to meet the design criteria of a particular application.

The RESS 102 is a high-voltage battery pack operational to store electrical energy. The RESS 102 is generally operational to receive electrical power from the DCFC interface circuit 112 (or similar electrical power source) and provide electrical power through the battery disconnect unit 104 to the traction inverter 108. The RESS 102 may include multiple battery modules electrically connected in series and/or in parallel. In various embodiments, the RESS 102 may provide approximately 400 to 1000 volts DC (direct current) electrical potential. Other battery voltages may be implemented to meet the design criteria of a particular application.

The battery disconnect unit (BDU) 104 directly connects the RESS 102 to the traction inverter 108. The battery disconnect unit 104 is operational to provide multiple switches or relays (not shown) that connect and disconnect the RESS 102 from the traction inverter 108.

The QRC is a self-starting quasi-resonant circuit that is operational to draw an AC signal through an internal impedance within the RESS 102. The AC signal passing through the internal impedance generates heat that warms the RESS 102. The heating may be performed while the RESS 102 is being charged, discharged and/or not being used.

The traction inverter 108 is a 3-phase DC to AC traction inverter. The traction inverter 108 is operational to convert the DC electrical power received from the RESS 102 into 3-phase AC electrical power that powers an electric motor.

The controller 110 implement a battery controller, an inverter controller, a QRC controller and a DCFC interface circuit controller. The controller 110 is generally operational to control the charging and discharging of the RESS 102.

The optional DCFC interface circuit 112 implements relays and diodes that are used to connect and disconnect the RESS 102 from the DCFC socket. The relays in the DCFC interface circuit 112 are controlled by the controller 110. In various embodiments, the DCFC interface circuit 112 is operational to connect the RESS 102 into two battery parallel packs to simultaneously charge both packs.

The optional DCFC socket 112 is a high voltage direct current charging socket. In various embodiments, the DCFC socket 112 may be compliant with the Society of Automotive Engineers (SAE) International J1772/CCS (combined charging system) standard, the International Electrotechnical Commission (IEC) 61851 standard and/or the IEC 62196-3 standard. The vehicle 100 may implement a DC Level 1 and/or DC Level 2 charging capabilities. Other standards may be implemented to meet the design criteria of a particular application.

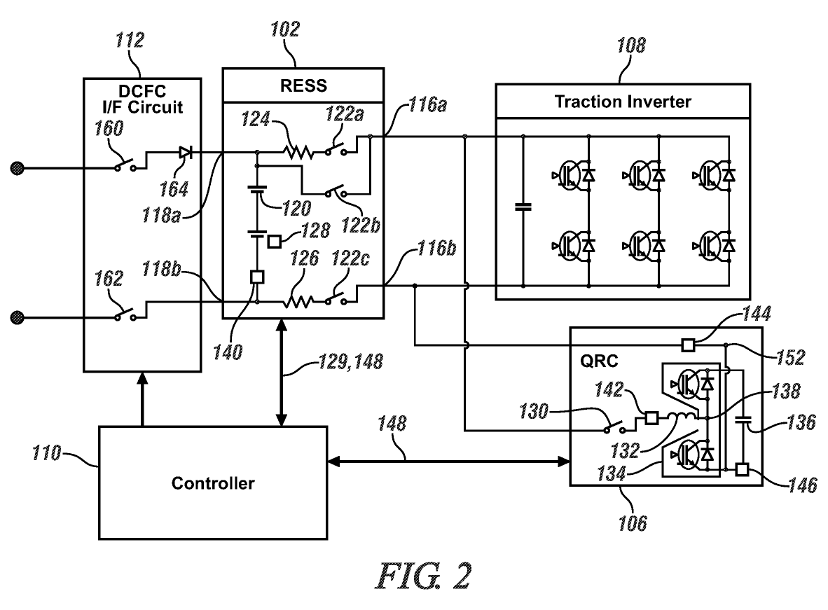

Referring to FIG. 2, a schematic diagram of an example implementation of various electronic configurations for RESS heating is shown in accordance with one or more exemplary embodiments. A stand-alone configuration generally includes the RESS 102, the quasi-resonant circuit 106, the traction inverter 108, the controller 110, and at least one current sensor 140-146. A direct current fast charging (DCFC) interface circuit 112 is included to achieve a “with DCFC” configuration.

The RESS 102 includes terminals 116a-116b, DCFC terminals 118a-118b, batteries 120, switches (or battery relays) 122a-122c, a pre-charge resistance 124, an internal impedance 126 and a battery temperature sensor 128. The terminals 116a and 118a may be positive terminals. The terminals 116b and 118b may be negative terminals. The switches 122b and 122c controllably connects the RESS 102 to the traction inverter 108. The switch 122a controllably bypasses an open switch 122b to pre-charge the RESS 102 through the pre-charge resistance 124. In various embodiments, the internal impedance 126 may be a parasitic impedance used in heating the RESS 102. In some embodiments, the internal impedance 126 may be an intentional impedance built into the busbars inside the RESS 102. In other embodiments, the internal impedance 126 may represent a lump ohmic internal resistance of each cell of the battery. The battery temperature sensor 128 is operational to generate a battery temperature signal 129 representative of a storage system temperature within the rechargeable energy storage system 102. The battery temperature signal 129 is transferred to the controller 110.

The QRC 106 includes a resonant switch 130, a high-current high-frequency AC inductor 132 (or “inductor” for short), a half-bridge power module 134, and a high-ripple-current capable DC capacitor 136 (or “resonant capacitor” for short). The half-bridge power module 134 includes an upper transistor and a lower transistor connected at a center node 138, and a pair of diodes in parallel with each respective transistor. Other DC and AC currents are drawn from the RESS 102 while the vehicle 100 is in an off state and/or is being recharged. The resonant switch 130 is absent in the permanently powered-on configuration.

The resonant switch 130 is in series with the inductor 132. The inductor 132 is coupled to the center node 138 of the half-bridge power module 134. While the resonant switch 130 in an open state, the QRC 106 does not draw current from the RESS 102 and no heating is achieved. While the resonant switch 130 in a closed state and the half bridge switches are suitably controlled, the QRC 106 generates an AC signal 150 that creates heat in the internal impedance 126 of the RESS 102. The inductor 132, the half-bridge power module 134, and the resonant capacitor 136 form a self-stating resonance circuit that creates the AC signal 150. The resonant switch 130 and the inductor 132 are used to isolate the QRC 106 from the rest of the high-voltage busses between the RESS 102 and the traction inverter 108.

The current sensors 140-146 generate a measured current signal 148 by measuring currents at various points in the system. The measured current signal 148 is transferred to the controller 110. The controller 110 uses the measured current signal 148 to define pulse parameters for the QRC 106.

A battery current sensor 140 may be integrated into the RESS 102. A first current sensor 142 may be integrated into the QRC 106 in series with the inductor 132. A second current sensor 144 is located at an AC output terminal 152 of the half-bridge power module 134. A third current sensor 146 is located at a lower side of the half-bridge power module 134. In some embodiments, the third current sensor 146 comprises current sensor power MOSFETs (e.g., a current mirror) to measure the switching current directly.

The DCFC interface circuit 112 includes a pair of battery relays 160-162 and a power diode 164. The battery relays 160-162 are controlled by the controller 110 to connect and disconnect the RESS 102 from a charging station while coupled to the DCFC socket (FIG. 1).

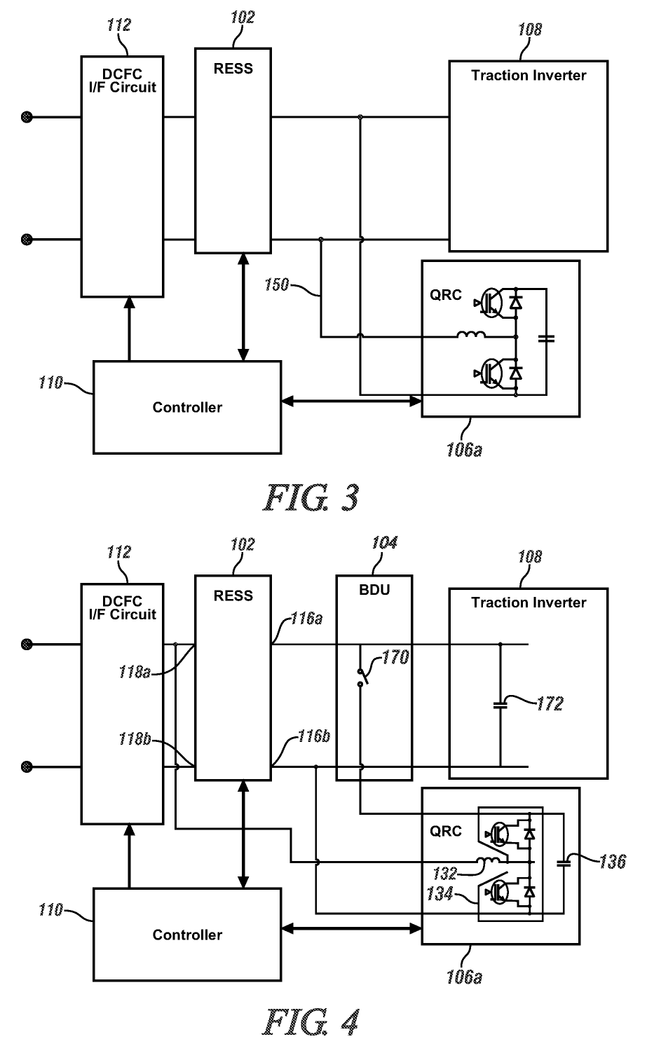

Referring to FIG. 3, a schematic diagram of an example implementation of another electronic configuration is shown in accordance with one or more exemplary embodiments. The electronic configuration illustrates a permanently powered-on DCFC interface circuit 112 configuration. The permanently powered-on configuration generally includes the RESS 102, a quasi-resonant circuit 106a, the traction inverter 108, the controller 110, and the optional DCFC interface circuit 112.

The QRC 106a is a variant of the QRC 106 without the resonant switch 130, as shown in FIG. 2. Therefore, the QRC 106a is constantly connected to the high-voltage direct current (HVDC) bus, but becomes operational after controlling the switches of the half bridge. In alternative embodiments, the QRC 106a may be replaced by the QRC 106 where the resonant switch 130 is normally closed, and the controller 110 does not command the resonant switch 130 to open.

Referring to FIG. 4, a schematic diagram of an example implementation of another electronic configuration is shown in accordance with one or more exemplary embodiments. The electronic configuration illustrated uses a filter capacitor within the traction inverter 108 with the QRC 106. The filter capacitor configuration includes the RESS 102, the BDU 104, the QRC 106a, the traction inverter 108, the controller 110 and the optional DCFC interface circuit 112.

The BDU 104 includes a disconnect switch 170 that alternatively connects and disconnects one side of the QRC 106a from one of the terminals 116a-116b (e.g., the positive terminal 116a as illustrated). The other side of the QRC 106a is connected to the other terminal 116a-116b (e.g., the negative terminal 116b as illustrated). The inductor 132 is connected to one of the DCFC terminals 118a-118b (e.g., the positive DCFC terminal 118a as illustrated).

The traction inverter 108 includes a filter capacitor 172 coupled across the terminals 116a-116b. While the disconnect switch 170 is closed, the filter capacitor 172 is electrically in parallel with the resonant capacitor 136 and thus increases the capacitance seen by the half-bridge power module 134. Therefore, the QRC 106a may resonate at a frequency dependent on the filter capacitor 172. In various embodiments, multiple traction inverters 108 may be included in the vehicle 100 and so multiple filter capacitors 172 may be electrically joined in parallel while the disconnect switch 170 is closed.

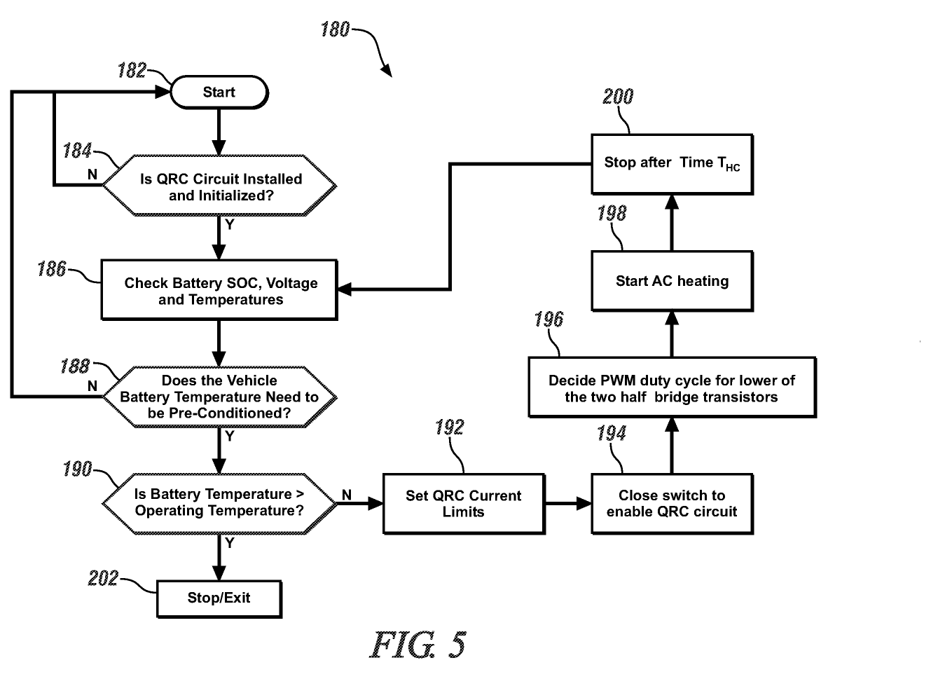

Referring to FIG. 5, a flow diagram of an example method of operation for the controller is shown in accordance with one or more exemplary embodiments. The method 180 (or process) is implemented by the controller 110. The method 180 generally includes steps 182 to 202, as illustrated. The sequence of steps is shown as a representative example. Other step orders may be implemented to meet the criteria of a particular application.

The method 180 begins in the step 182. In a decision step 184, the controller 110 determines if the QRC 106 is installed and initialized. If the QRC 106 is not installed and/or not initialized, the method 180 may return to the starting step 182. Where the QRC 106 is installed and initialized, the controller 110 may check the battery state-of-charge (SOC), battery voltage, the battery relay temperatures, and battery temperature in the step 186. In decision step 188, a check is performed to determine if the vehicle battery temperature such that the RESS 102 should be pre-conditioned. If the RESS 102 is sufficiently warm, the decision step 188 returns to the starting step 182.

Where the decision step 188 determines that the RESS 102 should be pre-conditioned, another check is made in the step 190 for the battery temperature relative to an operating temperature. If the battery temperature exceeds the operating temperature, the method 180 may end in the step 202. Otherwise, the controller 110 sets current limits for the QRC 106 in the step 192 based on the SOC, battery voltage, battery relay temperatures and/or the battery temperature. The resonant switch 130 is closed in the step 194 to enable the QRC 106. In the step 196, the controller 110 decides a pulse-width-modulation (PWM) duty cycle for the PWM signal applied to the lower of the two transistors in the half-bridge power module. The PWM duty cycle is based on an apriori look-up table of duty cycles and heating rates.

AC heating of the RESS 102 starts in the step 198 and a timer is started. The AC heating may stop in the step 200 a predetermined heating time (e.g., T_{HC}) after the AC heating has started in the step 198. Thereafter, the method 180 may return to the step 186 to recheck the battery SOC, the battery voltage, and the battery temperature. A loop around the steps 186 to 200 back to the step 186 until the battery temperature exceeds the operating temperature per the decision step 190 and the method 180 ends with the step 202.

In various embodiments, the electronic in a vehicle may provide a stand-alone quasi-resonant circuit for generating an AC current signal through the high-voltage rechargeable energy storage system. The QRC includes a half-bridge power module, a high-current high-frequency AC inductor, and a high-ripple-current capable DC capacitor. A current sensor may be embedded either within the inductor or at an AC output terminal of the half-bridge power module to measure the AC current through the inductor and the high-voltage batteries. Alternatively, a SENSEFET (e.g., current mirror) may be used in the lower side of the half-bridge power module to measure the switching current directly.

A controller is used to compare the current sensor signal with a reference value to generate a pulse width modulated signal that is applied at the gate of the lower transistor of the half-bridge power module to start the QRC operation. A switching frequency of the QRC is tuned to maximize the AC root-mean-square (RMS) current for a set peak current and/or achieve zero current switching for the lower transistor. A resonant switch in series with the inductor is used to isolate the QRC from the rest of the high-voltage busses. In various embodiments, the input filter capacitance of one or multiple traction inverters may be shared by the QRC circuit to control the resonant frequency of the AC signal.

The QRC may be operational while the vehicle is charging, while the vehicle is in motion, and while the vehicle is in a powered-down mode (e.g., switched off). Power devices within the QRC may share the same packaging as the traction inverters. By way of example, the QRC power devices may be mounted on the same heatsinks of the traction inverters.

A current sensor may be a battery current sensor that provides a battery RMS current value to the controller to define QRC pulse parameters. Frequency dithering is used to improve noise-vibration-harshness (NVH) (e.g., audible noise) of the QRC circuit. The frequency dithering causes a frequency of the AC signal to be spread across a band of frequencies rather than set at a single frequency. Furthermore, the RMS current of the QRC AC current signal may be limited depending on the battery SOC limits in the RESS, and temperatures of the switches, inductor, resonant capacitor, and the battery relays.

Embodiments of the system/methodprovide an independent half-bridge architecture that enables AC heating during many possible modes of vehicle operation. The heating system may be implemented in vehicles with no electric oil pumps, while the vehicle is in motion, and with vehicles having a single motor-drive unit. The heating system/method is compatible with 800 volt direct current (Vdc) or 400 Vdc DCFC, and with 400 Vdc traction inverters.

The AC heating uses battery internal impedance to ‘self-heat’. The system/method is able to heat the batteries without implementing convective heating methods (e.g., no external positive temperature coefficient (PTC) heaters). Furthermore, the system/method is able to heat the batteries in each possible modes of operation (e.g., while the vehicle is in motion, stationary, and/or during DCFC).

Embodiments of the disclosure generally provide a system that includes a rechargeable energy storage system, a quasi-resonant circuit, and a controller. The rechargeable energy storage system has a positive terminal, a negative terminal, an internal impedance, and a battery temperature sensor. The battery temperature sensor is operational to generate a battery temperature signal representative of a storage system temperature within the rechargeable energy storage system. The quasi-resonant circuit is coupled between the positive terminal and the negative terminal of the rechargeable energy storage system. The quasi-resonant circuit is operational to draw an alternating current signal through the internal impedance of the rechargeable energy storage system in response to a resonant control signal. The controller is coupled to the quasi-resonant circuit and the rechargeable energy storage system. The controller is operational to sense the storage system temperature within the rechargeable energy storage system via the battery temperature signal, and generate the resonant control signal in response to the battery temperature signal to heat the rechargeable energy storage system.

Numerical values of parameters (e.g., of quantities or conditions) in this specification, including the appended claims, are to be understood as being modified in each instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of values and further divided ranges within the entire range. Each value within a range and the endpoints of a range are hereby disclosed as a separate embodiment.

While the best modes for carrying out the disclosure have been described in detail, those familiar with the art to which this disclosure relates will recognize various alternative designs and embodiments for practicing the disclosure within the scope of the appended claims.

What is claimed is:

1. A system comprising:
a rechargeable energy storage system with a positive terminal, a negative terminal, an internal impedance, and a battery temperature sensor, wherein the battery temperature sensor is operational to generate a battery temperature signal representative of a storage system temperature within the rechargeable energy storage system;
a quasi-resonant circuit coupled between the positive terminal and the negative terminal, and operational to draw an alternating current signal through the internal impedance of the rechargeable energy storage system in response to a resonant control signal; and
a controller coupled to the quasi-resonant circuit and operational to:
sense the storage system temperature within the rechargeable energy storage system via the battery temperature signal; and
generate the resonant control signal in response to the battery temperature signal to heat the rechargeable energy storage system.

2. The system according to claim 1, wherein the quasi-resonant circuit comprises:
a half-bridge power module with a center node;
an inductor coupled to the center node; and
a resonant capacitor coupled in parallel with the half-bridge power module.

3. The system according to claim 2, further comprising:
a current sensor operational to generate a measured current signal representative of the alternating current signal, wherein:
the controller is further operational to generate the resonant control signal in response to the measured current signal.

4. The system according to claim 3, wherein:
the current sensor is in series with the inductor.

5. The system according to claim 3, wherein:
the half-bridge power module has an AC output terminal; and
the current sensor is at the AC output terminal.

6. The system according to claim 3, wherein:
the current sensor is a current mirror in series with the half-bridge power module.

7. The system according to claim 3, wherein:
the current sensor is a battery current sensor within the rechargeable energy storage system.

8. The system according to claim 3, wherein:
the rechargeable energy storage system includes a pair of direct current fast charging terminals through which the rechargeable energy storage system is rechargeable;
the inductor is directly connected to one terminal of the pair of direct current fast charging terminals; and
a switch disposed between the quasi-resonant circuit and the positive terminal of the rechargeable energy storage system, and controlled by the resonant control signal to alternatively connect and isolate the quasi-resonant circuit from the rechargeable energy storage system.

9. The system according to claim 3, wherein:
the controller is further operational to generate a pulse width modulated signal in response to the measured current signal;
the half-bridge power module has a first transistor with a first gate and a second transistor with a second gate; and
the second gate receives the pulse width modulated signal.

10. The system according to claim 9, wherein:
a switching frequency of the quasi-resonant circuit is tuned for zero current switching in the second transistor.

11. The system according to claim 2, wherein:
a switching frequency of the quasi-resonant circuit is tuned for a set peak current through the half-bridge power module.

12. The system according to claim 2, wherein the quasi-resonant circuit further comprises:
a resonant switch in series with the inductor and controlled by the resonant control signal to alternatively connect and isolate the quasi-resonant circuit from the rechargeable energy storage system.

13. The system according to claim 2, further comprising:
a traction inverter coupled to the positive terminal and the negative terminal of the rechargeable energy storage system, wherein:
the traction inverter provides a filter capacitor between the positive terminal and the negative terminal; and
the filter capacitor is coupled in parallel with the resonant capacitor while the quasi-resonant circuit is operational.

14. The system according to claim 1, wherein
the quasi-resonant circuit is operational while the rechargeable energy storage system is charging.

15. The system according to claim 1, wherein:
the rechargeable energy storage system, the quasi-resonant circuit, and the controller are disposed in a vehicle; and
the quasi-resonant circuit is operational while the vehicle is in motion.

16. The system according to claim 1, wherein the controller is further operational to dither the resonant control signal.

17. The system according to claim 1, wherein:
the rechargeable energy storage system has a state-of-charge and a plurality of battery relays; and
the controller is further operational to generate the resonant control signal in response to one or more of the state-of-charge and a plurality of relay temperatures of the plurality of battery relays.

18. The system according to claim 1, wherein:
the quasi-resonant circuit is directly connected to the positive terminal and the negative terminal of the rechargeable energy storage system; and
the resonant control signal is transferred from the controller directly to the quasi-resonant circuit.

19. A method for heating a rechargeable energy storage system comprising:
generating with a battery temperature sensor a battery temperature signal representative of a storage system temperature within the rechargeable energy storage system, wherein the rechargeable energy storage system has an internal impedance;
receiving at a controller the battery temperature signal;
generating in the controller a resonant control signal in response to the battery temperature signal; and
drawing with a quasi-resonant circuit an alternating current signal from the rechargeable energy storage system through the internal impedance in response to the resonant control signal to heat the rechargeable energy storage system.

20. A vehicle comprising:
a rechargeable energy storage system with a positive terminal, a negative terminal, an internal impedance, and a battery temperature sensor, wherein the battery temperature sensor is operational to generate a battery temperature signal representative of a storage system temperature within the rechargeable energy storage system;
a traction inverter coupled to the positive terminal and the negative terminal of the rechargeable energy storage system;
a quasi-resonant circuit coupled between the positive terminal and the negative terminal, and operational to draw an alternating current signal through the internal impedance of the rechargeable energy storage system in response to a resonant control signal; and
a controller coupled to the quasi-resonant circuit and operational to:
sense the storage system temperature within the rechargeable energy storage system via the battery temperature signal; and
generate the resonant control signal in response to the battery temperature signal to heat the rechargeable energy storage system.
